(19) United States
(12) Patent Application Publication
(10) Pub. No.: US 2004/0134343 A1
(43) Pub. Date: Jul. 15, 2004

(54) Tamper-resistant band clamp for spring brake actuator

(76) Inventors: Gregory R. Ashley, Amherst, OH (US); Leonard Quinn, Lagrange, OH (US); Fred Hoffman, Columbia Station, OH (US); Richard B. Jacobs, Avon Lake, OH (US)

Correspondence Address: CALFEE HALTER & GRISWOLD, LLP, 800 SUPERIOR AVENUE, SUITE 1400, CLEVELAND, OH, 44114, US

(21) Appl. No.: 10/342,553

(22) Filed: Jan. 15, 2003

(51) Int. Cl. F16J 3/00

(52) U.S. Cl. 92/63; 92/93

(57) ABSTRACT

A spring brake actuator comprises a housing including a first housing portion and a second housing portion. A spring disposed in the housing exerts a biasing force tending to separate the first housing portion from the second housing portion. A band clamp connects the first housing portion with the second housing portion. The band clamp comprises at least one band segment engaging the first and second housing portions, at least one fastener securing the band segment in a tamper-resistant manner, and a cover at least partially enclosing the fastener in a tamper-resistant manner.

### FIELD OF THE INVENTION

This invention relates to a spring brake actuator for use in a compressed air braking system of a vehicle. In particular, this invention relates to a mechanism for holding together the parts of the actuator housing, which encloses a powerful spring, in a tamper-resistant manner.

### BACKGROUND OF THE INVENTION

Many commercial vehicles use braking systems operated by compressed air. These systems commonly include a spring brake actuator, which is a mechanism that sets the vehicle brakes when compressed air is no longer provided to the system, such as when parking. A common type of spring brake actuator has a housing defining two chambers. Compressed air is selectively introduced into a first chamber to move a piston, push an actuator rod, and thereby operate the brake in a service brake manner. In a second chamber, compressed air constantly holds a second piston, connected with the actuator rod, in a disengaged position, whenever the vehicle is in operation. The compressed air in the second chamber acts against the bias of a powerful spring, compressing the spring. Should the air pressure in the second chamber decrease, for example when the vehicle is turned off to park, the spring expands and pushes the actuator rod to set and hold the brake in a parking brake manner.

The spring must be powerful enough to set the vehicle brake by itself. The spring is held in a multi-part housing that forms part of the spring brake actuator. The spring is enclosed inside the housing at the factory. It is important that the housing be maintained in a closed condition when the actuator is in use in the field. Disassembling the housing could lead to a rapid release of the large amount of energy stored in the spring.

### SUMMARY OF THE INVENTION

The present invention relates to a spring brake actuator comprising a housing including a first housing portion and a second housing portion. A spring disposed in the housing exerts a biasing force tending to separate the first housing portion from the second housing portion. In one embodiment, a band clamp connects the first housing portion with the second housing portion. The band clamp comprises at least one band segment engaging the first and second housing portions, at least one fastener securing the band segment in a tamper-resistant manner, and a cover at least partially enclosing the fastener in a tamper-resistant manner.

### BRIEF DESCRIPTION OF THE DRAWINGS

The foregoing and other features of the present invention will become apparent to one skilled in the art to which the present invention relates upon consideration of the following description of the invention with reference to the accompanying drawings, in which:

FIG. 1 is an elevational view, partially in section, of a spring brake actuator including a band clamp in accordance with a first embodiment of the present invention;

FIG. 2 is an enlarged sectional view of a portion of the actuator of FIG. 1, taken through a portion of the band clamp not including a fastener;

FIG. 3 is a plan view of a portion of the actuator of FIG. 1 including a tamper-resistant fastener;

FIG. 4 is a plan view of the band clamp shown in a disassembled condition;

FIG. 5 is a plan view of the band clamp shown in a partially assembled condition;

FIG. 6 is a plan view of the band clamp shown in a fully assembled condition;

FIG. 7 is an elevational view of the band clamp shown in a partially assembled condition;

FIG. 8 is an elevational view of the band clamp shown in a fully assembled condition; and

FIG. 9 is a sectional view taken generally along line 9-9 of FIG. 8.

### DETAILED DESCRIPTION OF THE INVENTION

This invention relates to a spring brake actuator for use in a compressed air braking system of a vehicle. In particular, this invention relates to a mechanism for holding together the parts of the actuator housing, which encloses a powerful spring, in a tamper-resistant manner. The invention is applicable to various spring brake actuator constructions. As representative of the present invention, FIG. 1 illustrates a spring brake actuator 10 constructed in accordance with a first embodiment of the invention.

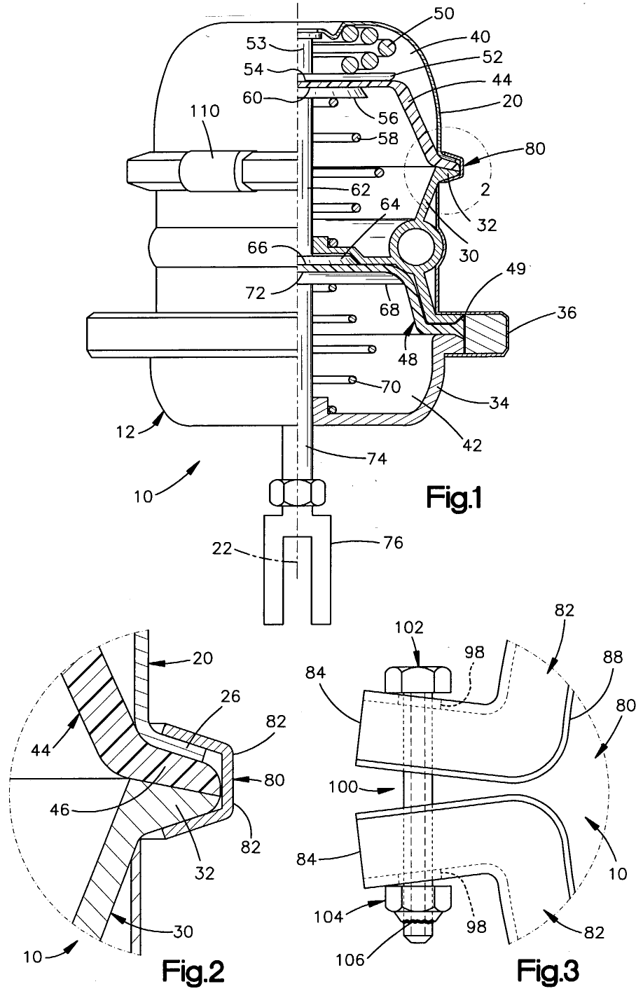

The actuator 10 includes a housing 12. The housing 12 includes a first portion 20 centered on an axis 22 of the actuator 10. In the illustrated embodiment, the first housing portion 20 (an upper portion as viewed in FIG. 1) is formed of sheet metal, although in other embodiments it could be formed differently, for example, as a casting. The first housing portion 20 has an annular, radially projecting flange 26 (FIG. 2).

The housing 12 also includes a second housing portion 30 (FIG. 1) centered on the axis 22. In the illustrated embodiment, the second housing portion 30 (an intermediate portion as viewed in FIG. 1) is a metal casting, although in other embodiments it could be formed differently, for example, as a stamping. The second housing portion 30 has an annular, radially projecting flange 32 (FIG. 2) that is adjacent the flange 26 of the first housing portion 20.

The actuator 10 includes a band clamp 80 that secures the first housing portion 20 to the second housing portion 30 by clamping together the flanges 26 and 32. The band clamp 80 is described below in detail.

The housing 12 further includes a third housing portion 34 centered on the axis 22. In the illustrated embodiment, the third housing portion 34 (a lower portion as viewed in FIG. 1) is also a metal casting, although in other embodiments it could be formed differently, for example, as a stamping. The actuator 10 includes a known clamp assembly 36 that secures the third housing portion 34 to the second housing portion.

The three housing portions 20, 30 and 34 define two chambers in the actuator 10. A first chamber 40 is defined between the first housing portion 20 and the second housing portion 30. A second chamber 42 is defined between the second housing portion 30 and the third housing portion 34.

The actuator 10 includes a first diaphragm 44. The first diaphragm 44 has an outer edge portion 46 (FIG. 2) clamped between the flange 26 of the first housing portion 20 and the flange 32 of the second housing portion 30. The first diaphragm 44 is movable in the first chamber 40 in a direction along the axis 22.

The actuator 10 also includes a second diaphragm 48. The second diaphragm 48 has an outer edge portion 49 (FIG. 1) clamped between the second housing portion 30 and the third housing portion 34. The second diaphragm 48 is movable in the second chamber 42 in a direction along the axis 22.

A power spring 50 and a first piston 52 are located in the first chamber 40 of the actuator 10. A first actuator rod portion 53 is connected with the first piston 52. The first piston 52 is in abutting engagement with an upper (as viewed in FIG. 1) side surface 54 of the first diaphragm 44. The power spring 50 acts between the first housing portion 20 and the first piston 52 to bias the first piston and thereby the first diaphragm 44 in a direction toward the second chamber 42, that is, in a downward direction as viewed in FIG. 1.

A second piston 56 and a return spring 58 are also located in the first chamber 40 of the actuator 10. The second piston 56 is in abutting engagement with a lower (as viewed in FIG. 1) side surface 60 of the first diaphragm 44, opposite the first piston 52. The return spring 58 acts between the second housing portion 30 and the second piston 56 to bias the second piston and thereby the first diaphragm 44 in a direction toward the power spring 50, that is, in an upward direction as viewed in FIG. 1.

A second actuator rod portion 62 connects the second piston 56 for movement with a third piston 64. The third piston 64 is located in the second chamber 42 and is in abutting engagement with an upper (as viewed in FIG. 1) side surface 66 of the second diaphragm 48.

A fourth piston 68 and a return spring 70 are also located in the second chamber 42 of the actuator 10. The fourth piston 68 is in abutting engagement with a lower (as viewed in FIG. 1) side surface 72 of the second diaphragm 48, opposite the third piston 64. The return spring 70 acts between the third housing portion 34 and the fourth piston 68 to bias the fourth piston and thereby the second diaphragm 48 in a direction toward the first chamber 40, that is, in an upward direction as viewed in FIG. 1. A third actuator rod portion 74 is connected for movement with the fourth piston 68 and terminates in a mounting ear 76.

The spring brake actuator 10 is operable in a known manner to move the third actuator rod portion 74 in a reciprocal manner to actuate a vehicle brake (not shown) connected with the mounting ear 76. Specifically, the first chamber 40 is normally pressurized with air under high pressure that keeps the second piston 56 and the first diaphragm 44 in the position shown in FIG. 1, in which the power spring 50 is substantially fully compressed.

When the vehicle brake is to be actuated, air under pressure is introduced into an upper portion of the second chamber 42, through a port not shown. The second diaphragm 48 moves downward, along with the fourth piston 68, against the bias of the return spring 70. This movement causes the third portion 74 of the actuator rod to move the mounting ear 76, in turn causing the vehicle brake to be actuated (set).

When the vehicle is turned off, or in an emergency situation, the air pressure in the first chamber 40 is decreased significantly. The force of the power spring 50 then acts to push the pistons 52, 56, 64 and 68, and the actuator rod portions 53, 62 and 74, in a direction (downward as viewed in FIG. 1) to actuate the vehicle brake. The power spring 50 is strong enough to actuate the vehicle brake, and to maintain it in an actuated condition to prevent the associated vehicle wheel from turning, without air pressure in the vehicle braking system. The power spring 50 is in a partially compressed condition when the brake is thus set.

Because the power spring 50 stores so much energy when even partially compressed, it is important that the first and second housing portions 20 and 30 be securely held together when the actuator 10 is in use in the field. Tampering with or disassembling the housing 12 when the power spring 50 is even partially compressed could lead to a rapid release of a large amount of energy stored in the power spring.

In the spring brake actuator 10, the band clamp 80 secures together the first and second housing portions 20 and 30 in a tamper-resistant manner. The band clamp 80 includes one or more band clamp segments. In the illustrated embodiment, the band clamp 80 includes two band clamp segments 82. In other embodiments, a different number of segments can be used; for example, a clamp having only one segment that extends completely around the housing 12 is possible.

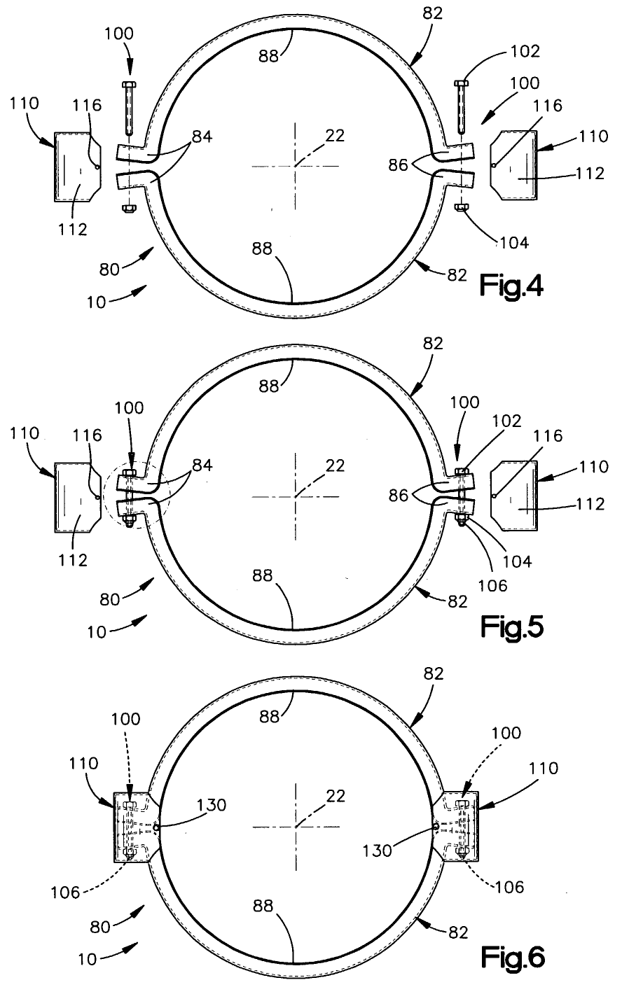

The two band clamp segments 82 in the illustrated embodiment are mirror images of each other. Each one of the band clamp segments 82 (FIGS. 4-6) includes first and second opposite end portions 84 and 86 and an intermediate portion 88. The intermediate portion 88 extends for approximately 180 degrees around the axis 22 and has an arcuate configuration centered on the axis. Each one of the first and second end portions 84 and 86 of the band segment 82 is formed as an ear that projects radially outward from the intermediate portion 88 and that has a fastener opening 98.

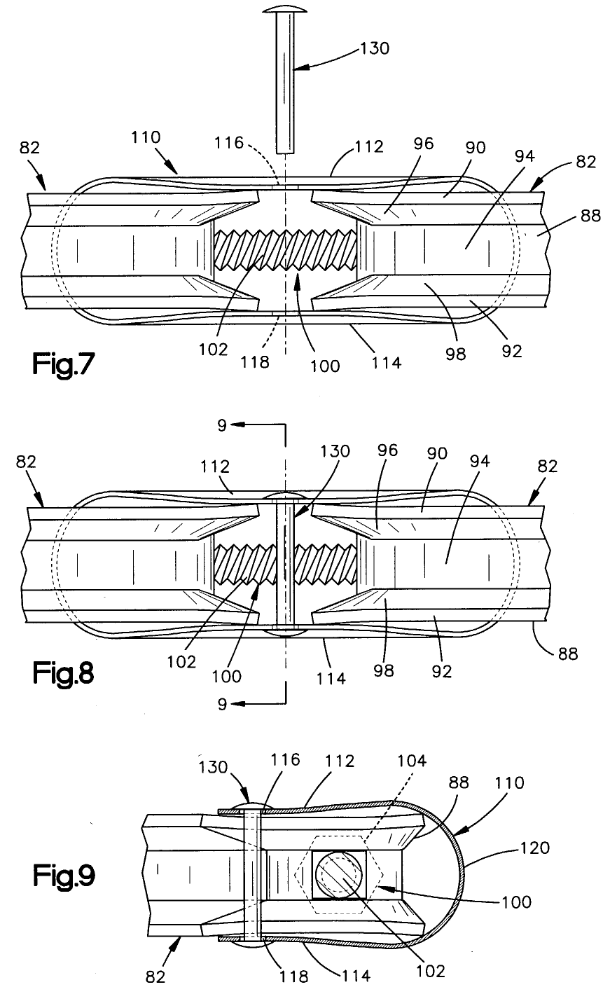

The intermediate portion 88 has a generally U-shaped cross-sectional configuration (FIGS. 7-9) including opposite side walls 90 and 92 defining a channel 94. The side walls 90 and 92 have facing angled internal surfaces 96 and 98, respectively.

In addition to the clamp segments 82, the band clamp 80 also includes one or more fasteners for securing the band clamp to the housing 12. In the illustrated embodiment, two fasteners 100 are provided which are identical to each other. Each fastener 100 includes a bolt 102 and a nut 104. In other embodiments, a different number of fasteners can be provided; for example, a band clamp 80 having a single band segment would need only one fastener.

The band clamp 80 also includes one or more covers for covering the fasteners of the band clamp. In the illustrated embodiment, two covers 110 are provided which are identical to each other. In other embodiments, a different number of covers can be provided; for example, a band clamp 80 having a single band segment would need only one cover.

Each cover 110, as illustrated, is preferably stamped from sheet metal and is shaped like a cap adapted to fit over end portions of the clamp segments 82 when the fasteners 100 are in position. Each cover 110 includes opposite side walls 112 and 114 in which are formed two fastener openings 116 and 118 aligned with each other. The side walls 112 and 114 are joined by an arcuate end wall 120.

When the band clamp 80 is applied to the housing 12 during assembly of the actuator 10, the two band segments 82 are placed on the flanges 26 and 32 of the first and second housing portions 20 and 30 respectively. The band segments 82 extend around and engage both flanges 26 and 32.

A first one of the bolts 102 (FIG. 3) is inserted through the fastener openings 98 in the first end portions 84 of the band segments 82. The head of the first bolt 102 engages the first end portion 84 of one band segment 82. A nut 104 is screwed on the bolt 102 and engages the first end portion 84 of the other band segment 82, as shown in FIG. 3.

A second bolt 102 (FIG. 4-6) is inserted through the fastener opening 98 in the second end portion 86 of one band segment 82. The head of the second bolt 102 engages the second end portion 86 of the one band segment 82. The second nut 104 is screwed on the second bolt 102 and engages the second end portion 86 of the other band segment 82.

The first and second fasteners 100 are tightened to a predetermined torque level. As this occurs, the angled inner surfaces 96 and 98 of the side walls 90 and 92 of the intermediate portions 88 of the band segments 82 draw the two housing flanges 26 and 32 together axially, with the first diaphragm 44 between them. The dimensions of the fasteners 100, and the dimensions and materials of the band segments 82, are selected so that the intermediate portions 88 of the band segments do not deform when the fasteners 100 are tightened. The band segment end portions 84 and 86 may deform slightly when the fasteners 100 are tightened. Deformation of the band segments 82 is not needed to clamp the flanges 26 and 32 together securely.

The nuts 104 are then welded to the bolts 102 as shown at 106 in FIGS. 3 and 5-6. The welding of the nuts 104 to the bolts 102 resists tampering with the band clamp 80, specifically, resists removal of the first and second fasteners 100 from the band clamp. The welding could be done in another manner, for example, the bolts 102 or the nuts 104 could be welded to the band segments.

The covers 110 are then assembled with the other parts of the band clamp 80 as shown in FIGS. 4-9. One cover 110 is placed in a position enclosing the first end portions 84 of the band segments 82 and also enclosing the associated fastener 100. When the cover 110 is thus in position, the fastener openings 116 and 118 in the side walls 112 and 114 of the cover are located behind (radially inward of) the shank of the bolt 102.

The cover 110 is then secured in position on the band clamp 80, in a tamper-resistant manner. In the illustrated embodiment, the cover 110 is riveted in position; in other embodiments, the cover could be secured in other tamper-resistant manners.

Specifically, a rivet 130 is inserted through the fastener openings 116 and 118 in the side walls 112 and 114 of the cover 110. The rivet 130 extends behind (radially inward of) the bolt 102. The rivet 130 is headed to secure the rivet to the cover 110. When the rivet 130 is thus secured to the cover 110, the rivet, which is located behind the bolt 102, resists removal of the cover from the band clamp 80.

The length of the rivet 130 is selected so that when the rivet is headed, the two walls 112 and 114 of the cover 110 are deformed inward into engagement with the first end portions 84 of the band segments 82. This engagement helps to prevent rattling of the cover 110 and also helps to secure the cover in position on the band clamp 80.

In a similar tamper-resistant manner, the other cover 110 is secured in a position enclosing the second end portions 86 of the band segments 82 and also enclosing the other fastener 100.

From the above description of the invention, those skilled in the art will perceive improvements, changes, and modifications in the invention. Such improvements, changes, and modifications within the skill of the art are intended to be included within the scope of the appended claims.

Having described the invention, we claim:

1. A spring brake actuator comprising:
a housing including a first housing portion and a second housing portion;
a spring disposed in said housing, said spring exerting a biasing force tending to separate said first housing portion from said second housing portion; and
a band clamp connecting said first housing portion with said second housing portion, said band clamp comprising:
at least one band segment engaging said first and second housing portions;
at least one fastener securing band segment in a tamper-resistant manner; and
at least one cover at least partially enclosing said fastener in a tamper-resistant manner.

2. An actuator as set forth in claim 1 wherein said at least one cover is riveted in position on said band clamp.

3. An actuator as set forth in claim 1 wherein said at least one fastener is a bolt and nut assembly, said nut being welded to said bolt.

4. An actuator as set forth in claim 3 wherein said cover is riveted in position on said band clamp.

5. An actuator as set forth in claim 3 wherein said rivet is located behind said bolt to resist removal of said cover from said band clamp.

6. An actuator as set forth in claim 2 wherein said cover is a cap-shaped metal member having first and second walls through which a rivet extends.

7. An actuator as set forth in claim 1 wherein the dimensions and materials of said band segment, and the dimensions of said at least one fastener, are selected so that said band segment does not deform when said fastener fastens said band segment in said tamper-resistant manner.

8. An actuator as set forth in claim 1 wherein said band clamp comprises first and second band segments engaging said first and second housing portions, first and second fasteners joining said first and second band segments in a tamper-resistant manner, and first and second covers at least partially enclosing said first and second fasteners in a tamper-resistant manner.

9. An actuator as set forth in claim 8 wherein each one of said first and second fasteners is a bolt and nut assembly, said nuts being welded to said bolts, and wherein each one of said covers is riveted in position on said band clamp.

10. A spring brake actuator comprising:
a housing including a first housing portion having a first flange and a second housing portion having a second flange;
a spring disposed in said housing, said spring exerting a biasing force tending to separate said first housing portion from said second housing portion; and
a band clamp connecting said first housing portion with said second housing portion, said band clamp comprising:
at least one band segment having opposite end portions and an intermediate portion engaging said first and second flanges;
a bolt engageable with at least one of said end portions of said band segment and a nut threaded on said bolt, said nut being welded to said bolt; and
a cover having a rivet securing said cover in position enclosing said bolt and said nut on said band clamp.

11. An actuator as set forth in claim 10 wherein said rivet is located behind said bolt to resist removal of said cover from said band clamp.

12. An actuator as set forth in claim 10 wherein cover is a cap-shaped metal member having first and second walls through which said rivet extends.

13. An actuator as set forth in claim 12 wherein the length of said rivet is selected so that said first and second walls deforms upon assembly of said rivet with said cover.

14. An actuator as set forth in claim 12 wherein the dimensions and materials of said band segment and the dimensions of said bolt are selected so that said band segment does not deform when said nut is tightened on said bolt.

15. An actuator as set forth in claim 10 wherein said band clamp comprises first and second band segments engaging said first and second housing portions, first and second fasteners joining said first and second band segments in a tamper-resistant manner, and first and second covers at least partially enclosing said first and second fasteners in a tamper-resistant manner.

16. An actuator as set forth in claim 15 wherein each one of said first and second fasteners is a bolt and nut assembly, said nuts being welded to said bolts, and wherein each one of said covers is riveted in position on said band clamp.

17. A spring brake actuator comprising:
a housing including a first housing portion and a second housing portion;
a spring disposed in said housing, said spring exerting a biasing force tending to separate said first housing portion from said second housing portion; and
a band clamp connecting said first housing portion with said second housing portion, said band clamp comprising:
a band segment engaging said first and second housing portions;
a fastener securing said band segment on said first and second housing portions; and
a cover at least partially enclosing said fastener in a tamper-resistant manner.

18. An actuator as set forth in claim 17 wherein said cover is a sheet metal stamping.

19. An actuator as set forth in claim 17 wherein said cover is riveted in position at least partially enclosing said fastener.

20. An actuator as set forth in claim 19 wherein said fastener is a bolt and nut assembly welded together.
